(19) United States
(12) Patent Application Publication
(10) Pub. No.: US 2015/0247928 A1
(43) Pub. Date: Sep. 3, 2015

(54) COOPERATIVE LOCATION SENSOR APPARATUS AND SYSTEM FOR LOW COMPLEXITY GEOLOCATION

(71) Applicant: Texas Instruments Incorporated, Dallas, TX (US)

(72) Inventors: Deric Wayne Waters, Dallas, TX (US); Gangadhar Burra, Plano, TX (US); Srinath Hosur, Plano, TX (US)

(73) Assignee: Texas Instruments Incorporated, Dallas, TX (US)

(21) Appl. No.: 14/193,048

(22) Filed: Feb. 28, 2014

(51) Int. Cl. G01S 19/03

(52) U.S. Cl. CPC G01S 19/03

(57) ABSTRACT

A location or position sensor apparatus and sensor systems are presented, in which individual location sensors store and wirelessly exchange orbital information, soft demodulation information, position and time of day information, and the sensors share decoding and computation tasks related to acquiring and tracking navigation satellites to conserve power and to facilitate determination of sensor positions.

### FIELD OF THE INVENTION

The present disclosure relates generally to satellite-based navigation or location sensors for determining present location through location and tracking of orbital satellites.

### BACKGROUND

Satellite positioning receivers (SPRs) or location sensors are in widespread usage for a variety of applications, such as portable or vehicle-based navigation systems, aircraft navigation systems, etc. A variety of different satellite-based positioning systems exist, such as the Global Positioning System (GPS), in which location sensors determine the current geolocation or position and current time information by tracking and receiving signals from multiple orbital satellites, using a localization algorithm to determine the current position. In the GPS system, for example, a group of orbital satellites each broadcast navigation messages in the same frequency band using different spreading sequences encoding information related to the satellite position. The GPS navigation messages are currently constructed as 25 frames, each including five subframes of 300 bits each, and the satellites broadcast the messages at a rate of 50 bits per second. The messaging from the GPS satellites, moreover, includes information relating to the time the message was transmitted and the position of the satellite at the time of transmission, as well as orbital information including ephemeris components specific to orbit of that satellite and almanac components with information and status related to all the satellites in the GPS satellite system. In operation, satellite-based location sensors (sometimes referred to as receivers) calculate their current position by determining the pseudorange to each tracked satellite based on the transmission and receipt times of a given message from a given satellite, and use computed pseudoranges for at least four satellites to compute the sensor location via a localization algorithm such as iterative least squares search based on linearization of the pseudorange equations. In order to perform a position determination computation, the location sensor tracks four or more visible satellites using the ephemeris and almanac information.

However, when the sensor initially powers up after a lengthy period of inactivity (cold start) neither the ephemeris, almanac nor the last position are known, and the sensor must acquire satellites and decode ephemeris information from the received navigation messages for a significant period of time in order to begin tracking and accurate position determination. In particular, the ephemeris is transmitted once every 30 seconds in a single navigation message, and the sensor must initially search for satellite messages before beginning to decode the orbital information obtained from the messages. A sensor may be “warm started” in a condition where almanac information is still current and the present time is known, but the sensor must still acquire a number of satellites and decode the ephemeris information to begin tracking. The initial operations to acquire satellites and decode ephemeris information take a significant amount of time and consume power to operate microprocessor and receiver circuitry of the location sensor. In certain applications, moreover, the amount of power required to begin tracking from a cold start condition is unavailable to the location sensor. Accordingly, a need remains for improved satellite-based location sensor apparatus and systems by which geolocation can be determined in an efficient manner, particularly where the sensor begins operation without current orbital, time and position information (a cold start).

### SUMMARY

The present disclosure provides new and improved apparatus, systems and methods by which low power sensor devices wirelessly exchange acquisition and tracking information with one another and share decoding and other computational results facilitating reduced power consumption by individual sensors to determine their positions in shorter time periods.

A location sensor apparatus is provided in accordance with one or more aspects of the present disclosure, which includes a processor and electronic memory, along with a wireless receiver to receive signaling from satellites, and a wireless transceiver to communicate with one or more other location sensors. The sensor processor is configured to identify or acquire a given satellite and to provide initially available information received from the satellite to the other sensors via the wireless transceiver. The processor decodes and locally stores orbital information related to the given satellite, provides the decoded orbital information to the other sensors, and selectively computes the sensor position at least partially according to the decoded orbital information in memory.

The sensor apparatus may cooperate with other sensors to share orbital information decoding tasks, such as decoding ephemeris information and almanac information. In certain embodiments, the sensor processor receives decoded orbital information related to one or more satellites from other sensors via the wireless transceiver, and stores this decoded orbital information in the electronic memory. In addition, the processor transmits the identity of a given satellite and a corresponding carrier-to-noise or signal-to-noise ratio to the other location sensors, and selectively decodes orbital information for that given satellite if the decoded information is not already in the electronic memory and if the other sensor or sensors are not decoding the orbital information related to that satellite with a sufficiently high carrier-to-noise or signal-to-noise ratio. In this manner, the cooperating sensor having appropriate sensitivity settings to first find the satellite signal will proceed to decode a given satellite's ephemeris, and other sensors that have identified or acquired that satellite can conserve time and energy by performing other tasks, with the decoding sensor eventually reporting the decoded orbital information when completed. In this manner, two or more sensors can work in parallel to decode ephemeris, almanac and/or other orbital information, with the group of sensors reaching steady state tracking and geolocation operation sooner than if each individual sensor performed all these tasks separately.

The sensor apparatus may exchange other important information with the other sensors via the wireless transceiver, for example by receiving and locally storing such information from other sensors, and computing, storing, and transmitting such information to the other sensors. In certain embodiments, the apparatus receives pseudorange information related to one or more of the satellites from at least one other sensor, and stores the received pseudorange information in the electronic memory. In addition, the apparatus in certain embodiments computes pseudorange information related to a given acquired satellite, stores the computed pseudorange information in the electronic memory, and provides this information to at least one other sensor via the wireless transceiver.

In certain embodiments, moreover, the sensor apparatus receives and stores soft demodulation information related to one or more satellites from another location sensor, and also provides soft demodulation information related to the given acquired satellite to the other sensors via the wireless transceiver. This sharing of soft information can advantageously facilitate the expeditious and accurate decoding of information by the group of sensors.

In various embodiments, the sensor apparatus receives and stores coarse and/or fine time of day information from one or more other sensors, and may determine time of day information based on signaling from the given acquired satellite and provide this to the other sensors via the wireless transceiver.

In certain embodiments, the sensor processor is configured to periodically provide time of day information to the other sensors via the wireless transceiver, thereby facilitating operation of other sensors in low-power or sleep mode, with the ability to enter normal operation and quickly receive a periodic time of day message.

In certain embodiments, moreover, the sensor apparatus receives position information from another sensor via the wireless transceiver, stores the received position information in the electronic memory, and provides its computed sensor position to the other sensors via the wireless transceiver.

The sensor apparatus may be further configured to send a help request message to one or more other location sensors via the wireless transceiver if it has not identified or acquired any satellites after a predetermined time period.

Certain embodiments of the sensor apparatus further facilitate expeditious time to first fix, with the sensor processor being configured to use available orbital information, such as ephemeris and/or almanac information in the electronic memory to initialize or update a satellite search when the sensor position or time of day becomes available. For example, the sensor in certain embodiments may use available almanac information and position or time of day information to selectively discontinue or stop searching for one or more of the satellites which are known to be not currently visible. In another example, the sensor apparatus may use available ephemeris information related to a given acquired satellite to narrow a search for the satellite around an expected Doppler frequency indicated in the ephemeris information.

In certain embodiments, moreover, the sensor apparatus wirelessly receives an indication that another sensor is searching for a particular satellite, and selectively refrains from searching for that satellite if the other sensor has been searching longest for that particular satellite.

In accordance with further aspects of the disclosure, systems are provided, including a plurality of location sensors which individually include a processor, memory, a wireless receiver to receive communications signaling from satellites, and a wireless transceiver to communicate with one or more other location sensors. The individual location sensors of the system store and cooperatively exchange information related to acquiring and tracking four or more satellites to facilitate determination of their positions through a localization algorithm, for example. The location sensors in certain embodiments, moreover, individually search for satellites by random or arbitrary selection of a satellite index and search beginning at a random circular rotation of a pseudorandom noise sequence, as well as wireless broadcasting of the selected satellite index to the other sensors. In this manner, the likelihood that a given satellite will be searched increases, and the sharing of satellite searching resources of the sensors is facilitated.

The individual location sensors in certain embodiments of the system intelligently share decoding tasks and information, with the individual sensors receiving and locally storing decoded orbital information from another sensor. In addition, the individual location sensors in these embodiments indicate the identity of the given acquired satellite and a corresponding carrier-to-noise or signal-to-noise ratio using the wireless transceiver, and selectively decode the orbital information if not already in memory and if another sensor is not decoding the same orbital information with a sufficiently high carrier-to-noise or signal-to-noise ratio. The individual sensor may thus refrain from decoding the orbital information if decoded orbital information is already available in the electronic memory or if another sensor with a sufficient carrier-to-noise or signal-to-noise ratio is already decoding that information.

In certain embodiments, moreover, two or more of the sensors use different sensitivity settings to search for satellites, so that some sensors look only for satellites with high signal-to-noise ratios while others will also identify or acquire satellites with low signal-to-noise ratios.

The individual sensors in certain embodiments may also provide initial information received from a located satellite to the other sensors via the wireless transceiver, including the located satellite index, a carrier-to-noise or signal-to-noise ratio of the signal received from the located satellite, a Doppler frequency associated with the located satellite, and a pseudorandom noise sequence location at which the signal was found.

In certain embodiments, the individual location sensors cooperate to compute the distance between themselves to improve performance and accuracy.

### DESCRIPTION OF THE VIEWS OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings, in which:

FIG. 1 is a simplified schematic diagram illustrating a location sensor apparatus with a processor, an electronic memory, a GPS receiver and a wireless transceiver for exchanging information with other similar sensors in accordance with one or more aspects of the present disclosure;

FIG. 2 is a system diagram illustrating a plurality of location sensors receiving signaling from a group of navigation satellites and communicating with one another via wireless transceivers according to certain aspects of the disclosure;

FIG. 3 is a flow diagram illustrating an exemplary high-level method for operation of location sensors in the system of FIG. 2;

FIG. 4 is a detailed flow diagram illustrating an exemplary method for satellite acquisition in the sensor apparatus of FIG. 1;

FIG. 5 is a detailed flow diagram illustrating an exemplary ephemeris and almanac decoding process in the sensor apparatus of FIG. 1;

FIG. 6 illustrates an exemplary GPS message frame having five subframes including timing and orbital information relating to an acquired satellite; and

FIGS. 7A and 7B provide a flow diagram illustrating another exemplary process for operating the location sensor apparatus of FIG. 1.

### DETAILED DESCRIPTION

One or more embodiments or implementations are hereinafter described in conjunction with the drawings, wherein like reference numerals are used to refer to like elements throughout, and wherein the various features are not necessarily drawn to scale. The present disclosure provides a location sensor apparatus for use in satellite-based navigation systems using cooperation among multiple sensors for satellite acquisition and tracking. The various concepts of the disclosure may be advantageously employed to facilitate deployment, use, and maintenance of a remote satellite-based navigation system that must accurately track its position and report information in a reduced power mode while facilitating short time to first fix, although the disclosed apparatus and techniques find utility in other usage scenarios and are not limited to the aforementioned applications.

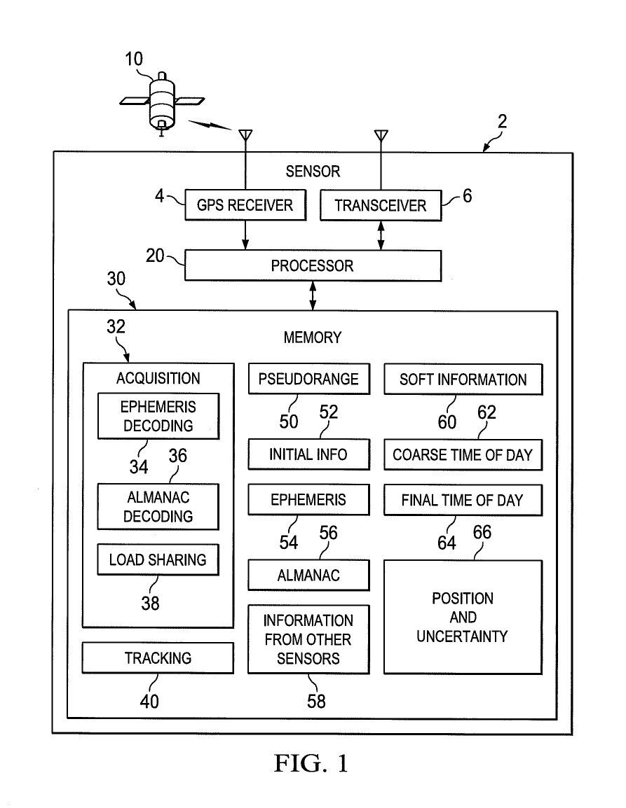

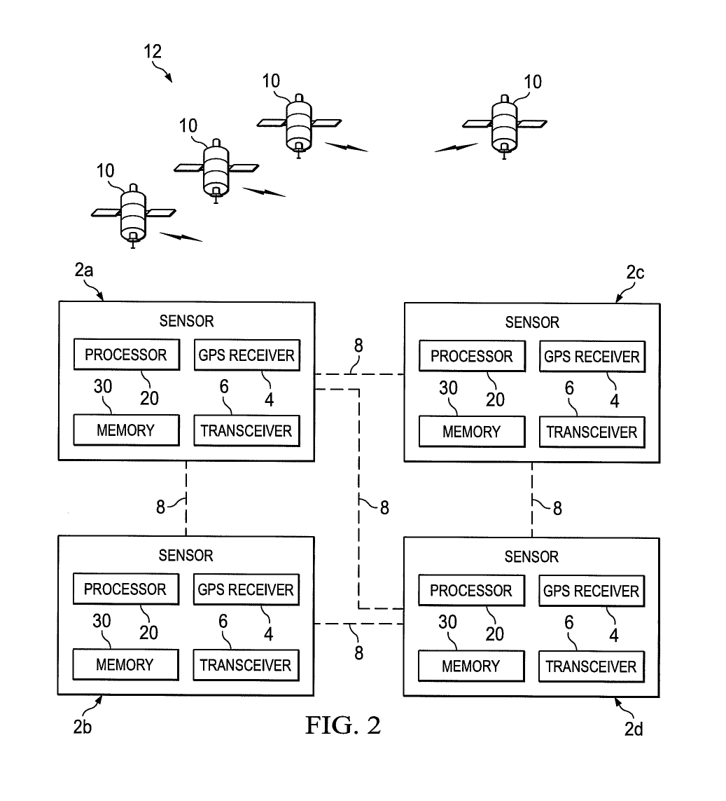

Referring initially to FIGS. 1, 2 and 6, FIG. 1 illustrates an exemplary navigation or location sensor apparatus 2, and FIG. 2 shows an exemplary cooperative sensor system 12 including multiple sensors 2a-2d with two-way wireless communication links 8 between various location sensors 2a-2d, as well as a plurality of navigation satellites 10. The sensors 2 and systems of the present disclosure are amenable to use with any suitable satellite-based positioning including without limitation Global Positioning System (GPS), Galileo, Global Navigation Satellite System (GLONASS), The BeiDou Navigation Satellite System (BDS), Quasi-Zenith Satellite System (QZSS), etc. The illustrated sensor apparatus embodiment 2 is described in the context of a non-limiting GPS implementation, and includes a receiver 4 operative to receive signaling and information from GPS satellites 10, as well as a wireless transceiver 6 providing two-way communications with one or more other location sensors 2, such as illustrated by the dashed-line communication links 8 in the system 12 of FIG. 2. In addition, the illustrated sensor apparatus 2 includes a processor 20 and an associated electronic memory 30. The processor 20 may be any suitable microprocessor, microcontroller, processor core, programmable logic, etc., and may be configured or programmed with suitable programming instructions such as software and/or firmware to implement the functionality set forth hereinafter along with other tasks associated with satellite-based geolocation and navigation, where the programming instructions may be stored in the electronic memory 30 along with various information and data 32-66 as illustrated in FIG. 1 in certain embodiments.

In particular, the processor 20 in this example is programmed to perform various geolocation processing for determining its current position based on data and information received from satellites 10 and from other sensors 2, and to share GPS processing related information with the other sensors 2 for load and information sharing purposes to facilitate reduction in power consumption of the individual sensors 2 while implementing GPS satellite location, acquisition and tracking functions. The processor 20 and apparatus 2, moreover, are operable to implement various tasks and functions associated with GPS processing, examples of which are set forth in U.S. Pat. No. 8,441,398 to Rao et al., issued May 14, 2013, the entirety of which is hereby incorporated by reference.

In addition, the sensor 2 is programmed or otherwise configured to implement load sharing with other sensors 2 via wireless communication using the transceiver 6 by which the GPS processing can be shared among multiple sensors 2, thereby reducing the power consumption requirements of the individual sensors 2 and the system 12 as a whole. The sensor 2 is thus operable to transmit or broadcast information to other sensors 2 regarding GPS satellite information it has acquired, and to receive such information transmissions from other sensors 2, and to improve positioning or navigation performance by sharing information once a satellite vehicle 10 has been identified or acquired, with the sensors 2 being further configured to cooperate to improve sensitivity for demodulating GPS data bits.

As seen in FIG. 1, the sensor memory 30 includes program instructions or components 32 and 40 for satellite acquisition and tracking, respectively, as well as data structures for storing satellite acquisition and transaction information 50-66. In the example of FIG. 1, the data in the sensor memory 30 includes a pseudorange for a given located satellite 10, immediately or initially available information 52 received from a located satellite 10, as well as decoded ephemeris data 54 for one or more located satellites 10 and almanac data 56 pertaining to a plurality of satellites 10, such as the 32 GPS system satellites. Both the ephemeris information 54 and the almanac information 56 provide orbital information related to one or more satellites 10, and are hereinafter referred to as orbital information. In addition, the memory 30 stores information or data 58 received from other location sensors 2, soft demodulation information 60 from this or other sensors 2, coarse time of day information 62, fine time of day information 64, and position and corresponding uncertainty information 66 for one or more located satellites 10. The acquisition computation component 32 includes an ephemeris computation component 34, an almanac computation component 36, and a load sharing component 38 and are implemented or executed by the processor 20.

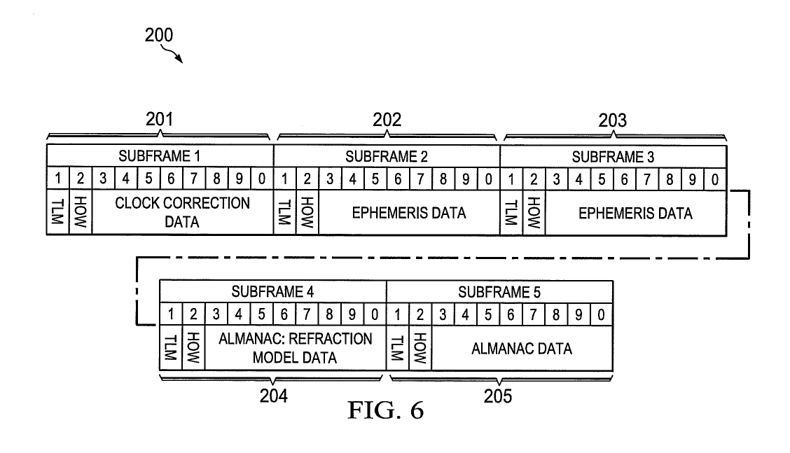

An exemplary GPS navigation message frame 200 is illustrated in FIG. 6, including subframes 201, 202, 203, 204 and 205. The first subframe 201 includes satellite clock correction data as well as telemetry (TLM) and handover (HOW) words, with the second and third subframes 202 and 203 including telemetry and handover words as well as ephemeris data describing the precise orbit of the transmitting satellite, and the fourth and fifth subframes 204 and 205 including almanac data providing coarse orbit and status information for up to 32 satellites 10 as well as data related to error correction. A given satellite 10 in the GPS example will send a navigation message including 25 such frames 200 at a bit rate of 50 bits per second, and transmission of each complete message therefore takes 750 seconds. The ephemeris data is repeated in every frame, but each frame only includes a piece or portion of the full almanac data. Therefore, it takes 30 seconds or less for a receiver to see a complete set of ephemeris data for the transmitting satellite in the GPS example. All satellites 10 broadcast at the same frequencies, with the individual signals being encoded via code division multiple access (CDMA) such that messages from individual satellites 10 are distinguishable by a unique coding, such as the coarse/acquisition (C/A) code in a general GPS implementation. In the GPS example, moreover, the ephemeris is updated every 2 hours and is generally valid for 4 hours, with provisions for updates every 6 hours or longer in non-nominal conditions, while the almanac is typically updated once per day.

Returning to FIG. 1, the ephemeris computation component 34 calculates or decodes ephemeris data 54 based at least in part on the communications signaling received from the given satellite 10 this decoded data includes the location of the satellite 10 at a particular point in time from a set of parameters. The almanac computation component 36 calculates or decodes the almanac information 56 including the approximate orbit of a set of satellites 10. The location sensor 2 stores this information in memory 30 so that it can be used to determine the Doppler shift of each satellite and configure the acquisition channel for each satellite when it is needed. Decoding of the almanac 56 involves the location sensor 2 locating and listening to the communications from the satellite 10 for an extended period of time, and the load sharing component 38 advantageously implements various cooperative sharing techniques among the sensors 2, allowing an individual sensor 2 to send the ephemeris 54 and almanac 56 information it has decoded and receive decoded ephemeris 54 and almanac 56 information from other location sensors 2 to assist in reducing power consumption and reducing the Time to First Fix (TTFF) for a system 12 in FIG. 2 having multiple sensors 2. The time to first fix is the time and process required for a GPS device to acquire enough information to begin accurate position determination.

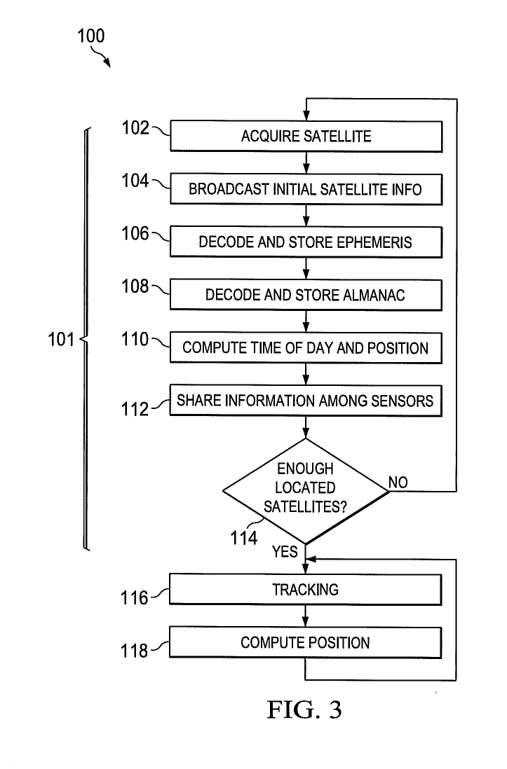

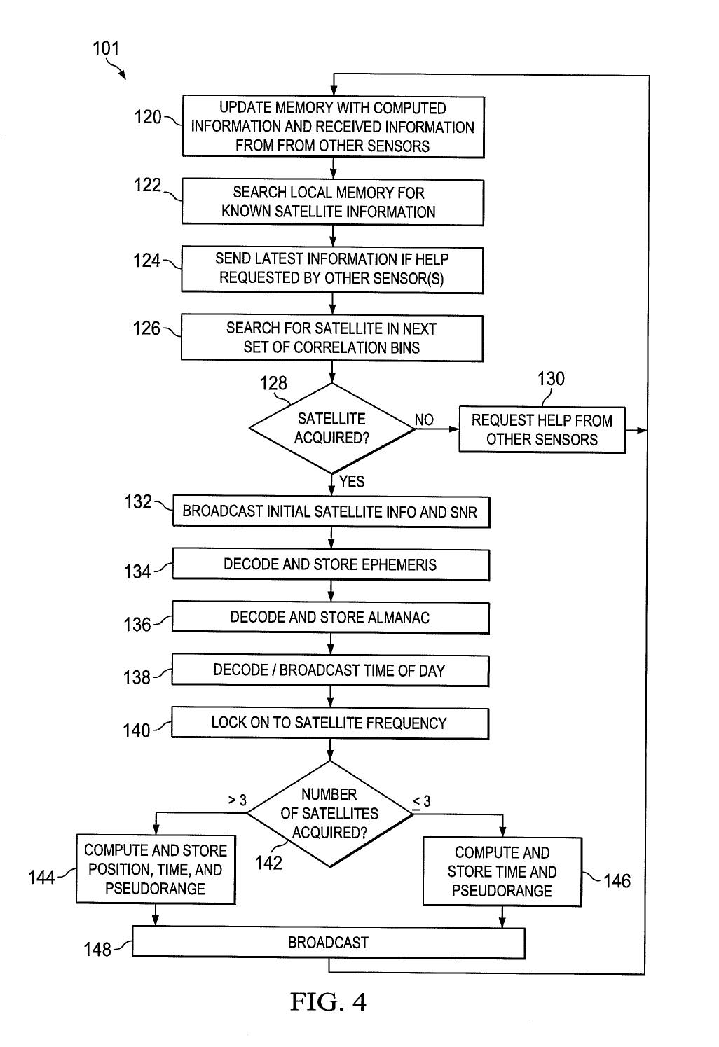

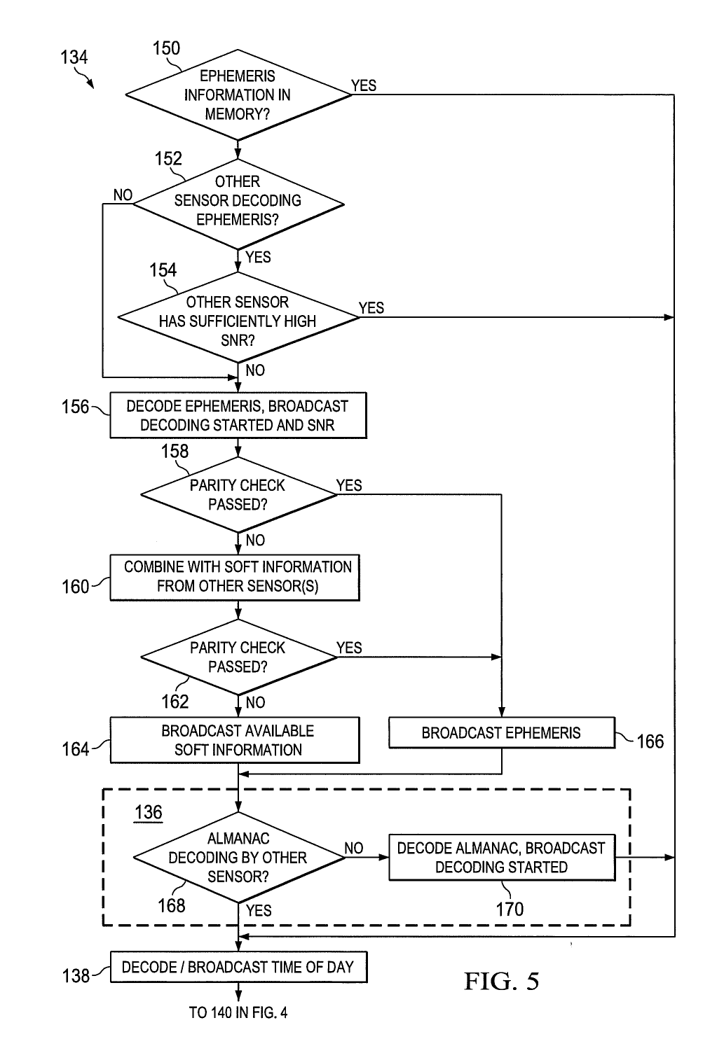

Referring to FIGS. 3-4, an exemplary method 100 is illustrated for acquiring satellite information used for accurate position tracking in satellite-based sensor systems. Although the method 100 is illustrated and described below in the form of a series of acts or events, it will be appreciated that the various methods of the disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated method 100 may be implemented in hardware, processor-executed software, processor-executed firmware or combinations thereof, such as in the exemplary location sensor 2 described above, and may be embodied in the form of non-transitory computer executable instructions stored in a computer readable medium, such as in the memory 30 operatively associated with the sensor processor 20 in one example.

Upon start-up, the location sensor 2 begins acquisition processing 101 in FIG. 3, and identifies a given satellite 10 at 102 and acquires satellite information for the given satellite 10 prior to tracking and providing position data. The satellite identification or acquisition at 102 in certain embodiments involves satellite searching with the processor 20 randomly selecting a satellite index or identifier from a list of previously unlocated satellites stored in the memory 30, as well as a random selection from a pseudorandom noise (PRN or PN) sequence to enhance the probability that a particular satellite index will be found quickly. Once a satellite 10 is located at 102, the location sensor 2 broadcasts the initially available satellite information 52 to other location sensors 2 at 104. At 106, the sensor 2 decodes and stores the ephemeris data 54 and decodes and stores the almanac data 56 at 108. As seen in FIG. 6, within most frames, subframe 4 contains the almanac data from one satellite and subframe 5 contains the almanac data from another satellite in the GPS example. The location sensor 2 need not wait until the entire almanac is decoded before sharing it with other location sensors. After the almanac for a new satellite is found it can be transmitted to the other location sensors so that they can update their satellite search 312. With this, the location sensor 2 computes the time of day 62, 64 and position information 66 at 110 and shares this and other information at 112 with other location sensors 2. Each of the location sensors 2 in the non-limiting example of FIG. 2 is operative to share its decoded information with all other location sensors 2 (this includes the ephemeris and/or partial almanac data and/or full almanac data as decoded from the satellite signaling), depending on range limitations of the wireless transceivers 6, thus reducing the time spent and energy consumed by each location sensor 2 to locate and decode a certain number of satellites 10 for accurate position tracking, thereby reducing power consumption for all the location sensors 2.

After decoding information about the located satellite 10 and broadcasting this information to other sensors, the location sensor 2 checks its local information 50, 52, 54, 56, 58, 60, 62, 64, 66 stored in memory 30 and makes a determination at 114 as to whether enough satellite indexes have been located to begin tracking position information. The local list of information contained in the data structures of memory 30 in one embodiment includes a concatenated list of the satellite indexes that have been acquired and their strength, the time of day, a pseudorange, Doppler frequency and time stamp of measurements for each satellite index. This information can be used to improve performance of each location sensor 2 by isolating/mitigating a multipath. If enough satellites have been located (YES at 114), the location sensor 2 moves to the tracking phase at 116 and computes its position at 118. Otherwise (NO at 114), the location sensor 2 continues the acquisition processing 101 as described above.

FIG. 4 illustrates a non-limiting detailed implementation of the acquisition processing 101 of FIG. 3, with the sensor 2 updating the local memory 30 at 120 with computed information and received information from other sensors 2. At 122, the sensor 2 searches the memory 30 for known satellite information and sends the latest information at 124 if a help request message is received from another sensor 2 via the wireless transceiver 6. At 126, the sensor 2 begins searching for the selected satellite index, and determines at 128 whether the searched satellite 10 is identified or acquired. If no satellite identified in a predetermined time period (NO at 128), the sensor 2 may send a help request message at 130 via the wireless transducer 6 to solicit assistance from other sensors 2, and the process returns to 120 as described above. This help request concept facilitates locking of all location sensors 2 in the system 12 onto a satellite frequency, where the predetermined time period can be coded in hardware or software within the location sensor 2.

If the searched satellite has been identified or acquired (YES at 128), the location sensor 2 stores and broadcasts the initially available information 52 to the other sensors at 132. In certain embodiments, the initially available information 52 can include the index of the located satellite 10, the carrier-to-noise ratio or the signal-to-noise ratio of the satellite signal, the Doppler frequency, and the location in the pseudorandom noise sequence where the satellite 10 was found. The navigation sensor 2 then proceeds to decode and store the ephemeris data 54 at 134 in FIG. 4, and to decode and store almanac information 56 at 136. The location sensor 2 locks onto the satellite frequency at 140 to obtain multiple pseudorange measurements to improve accuracy in predicted pseudorange change over time and to reduce the receiver clock drift, and determines the number of satellites 10 that have been located at 142. If more than three satellites 10 have been located, the sensor 2 computes and stores the position and uncertainty 66 at 144 in FIG. 4, along with the time 62, 64 and pseudorange 50. If more than one but less than three satellites have been located at 142, the location sensor 2 computes the time and pseudorange at 146. The location sensor 2 then broadcasts the computed time and pseudorange (and any computed position) at 148 to the other location sensors 2, and the process returns to 120 as described above.

FIG. 5 illustrates further details of an exemplary ephemeris decoding process 134, where the sensor 2 initially determines at 150 whether the decoded ephemeris information for a given satellite 10 is currently in the local memory 30, and if so (YES at 150) refrains from decoding the ephemeris of the currently identified satellite 10 and proceeds to decode and broadcast the time of day 138 based on the current time information received from the satellite 10. If the ephemeris information is not available (NO at 150), the sensor 2 proceeds to 152 to determine if another navigation sensor 2 has indicated it is decoding the ephemeris for that given satellite 10. In one possible embodiment, the sensor 2 makes this determination based on prior information or responses 58 from the other sensors 2 stored in the memory 30 in FIG. 1. If not (NO at 152), the sensor 2 proceeds to decode the ephemeris at 156, and broadcasts a message to the other sensors 2 indicating that decoding of this ephemeris has begun along with its corresponding carrier-to-noise or signal-to-noise ratio.

If the responses 58 from the other sensors indicate that another sensor 2 is decoding the ephemeris (YES at 152), the sensor 2 determines from the information 58 provided by the other sensor 2 whether the other decoding sensor 2 has a sufficiently high carrier-to-signal or signal-to-noise ratio. If not (NO at 154), the sensor proceeds to attempt to decode the ephemeris at 156, and broadcasts that the decoding has begun, where the broadcast message indicates the sensor's carrier-to-noise or signal-to-noise ratio. By this technique, the other sensor 2 will be informed that the current sensor 2 is decoding with a sufficiently high carrier-to-noise or signal-to-noise ratio, and may discontinue decoding that ephemeris by similar operation in that sensor 2. If the other location sensor 2 has begun decoding the ephemeris but has a sufficiently high carrier-to-noise or signal-to-noise ratio than the querying location sensor 2 (YES at 154), the location sensor 2 selectively refrains from decoding this ephemeris and may wait for the ephemeris to become available from the other sensor 2 and then proceed with decoding and broadcasting the time of day information at 138, with the process then returning to 140 in FIG. 4. In another possible implementation, the process proceeds directly from 154 (YES) to 140 or 142 in FIG. 4 without awaiting completion of the ephemeris decoding. Thus, the illustrated ephemeris decoding operation 134 of the location sensor 2 advantageously facilitates utilizing only one sensor 2 for decoding a given ephemeris in the system 12, and advantageously selects the first sensor 2 having sufficiently high carrier-to-noise or signal-to-noise ratio.

Following the ephemeris decoding at 156, the sensor 2 performs a parity check and determines at 158 whether the parity check was successful (passed). If the parities match (YES at 158), the ephemeris was properly decoded and the location sensor 2 stores the decoded ephemeris 54 in the memory 30 and broadcasts the ephemeris information at 166 for use by other location sensors 2. If the parities do not match (NO at 158), the ephemeris was not properly decoded, and the sensor 2 combines the decoded ephemeris information at 160 with other soft information 60 available from the other location sensors 2 and conducts another parity check at 162. If the parities now match (YES at 162), the location sensor 2 saves and broadcasts the decoded ephemeris information 54 at 166 for other location sensors 2 to use. In certain embodiments, the parity check can be conducted again at 162 in a loop including soft information combination at 160 and parity check at 162, and ending after a defined number of cycles in the hardware or software within the location sensor's memory 30. If after the defined number of parity check loop cycles is conducted the parities do not match (NO at 162), the location sensor 2 broadcasts the available soft information at 164 for other location sensors 2 to use in decoding the ephemeris in the future.

Once the soft information has been broadcast at 164 or the successfully decoded ephemeris 54 has been broadcast at 166, the sensor 2 proceeds to selectively attempt almanac decoding at 136. As seen in FIG. 5, a determination is made at 168 as to whether another sensor has begun decoding the almanac portion of the current message, and if so (YES at 168), the sensor 2 in one example refrains from decoding the almanac portion and proceeds to decode and broadcast the time of day at 138. If no other sensor 2 is decoding the almanac (NO at 168), the sensor 2 begins almanac decoding and broadcasts a message to the other sensors 2 that decoding of this almanac portion has begun, and continues to decode the almanac portion at 170. Once the almanac portion is decoded, the sensor 2 stores the decoded almanac information 56 in the memory 30 (FIG. 1), and decodes and broadcasts the time of day at 138. Following the decoding and broadcasting and 138, processing by the sensor 2 then continues at 140 in FIG. 4 as described above. The almanac may thus be decoded in portions, with multiple sensors 2 decoding separate portions, reporting the portions they are working on, and reporting the completed portions for load and information sharing among the sensors 2. For example, different sensors may decode the almanac data from different frames. Also within a frame, the sensor 2 in certain embodiments may go to a low-power mode (or temporarily start acquiring another satellite) until subframes 4 and 5 are received including useful information while it is only trying to decode the almanac.

The exemplary sensor apparatus 2 thus operates as part of an efficient expeditious system 12 (e.g., FIG. 2) with the individual location sensors 2 storing and wirelessly exchanging orbital information, soft demodulation information, position and time of day information via the wireless communication links 8, where the sensors 2 intelligently share decoding and computation tasks and results related to acquiring and tracking navigation satellites 10 to conserve power and to facilitate sensor position determination via localization algorithms such as iterative least squares. In certain implementations, the individual sensors 2 initially search for satellites 10 by randomly selecting a satellite index 32 corresponding to an unlocated satellite 10 (e.g., from a satellite index list in the memory 30), and wirelessly broadcast the selected index to the other sensors 2. The inventors have appreciated that as the number of participating sensors 2 increases, the probability that each satellite 10 will be searched by at least one sensor 2 also increases, thus expediting the acquisition processing by the system 12. In addition, the individual sensors 2 in certain embodiments begin the search for the selected satellite 10 at a random circular rotation of the internal pseudorandom number sequence, thereby increasing the probability that a satellite 10 will be identified or found quickly. As a result, the sensor apparatus 2 and systems 12 employing two or more such sensors 2 facilitate sharing of satellite searching resources among the location sensors 2.

In certain implementations, two or more of the location sensors 2 use different sensitivity settings to search for satellites 10. In this manner, some sensors 2 will identify only high signal-to-noise ratio satellites 10, while other sensors 2 will also find lower signal-to-noise ratio satellites 10. Other embodiments are possible, for example, with each sensor 2 being configured to a certain sensitivity setting to simplify the implementation. Moreover, the illustrated embodiments advantageously share acquired information with other sensors 2, where the information sharing may be implemented using broadcast messaging, or messages to specific sensors are possible in certain embodiments. For example, once a satellite 10 has been identified by the location sensor 2, certain parameters are known as soon as a peak is found, and accordingly the sensor 2 provides this information via the wireless transceiver 6 to the other sensors 2 without waiting for ephemeris, pseudorange, almanac, etc. to be computed, where the immediately or initially available information 52 in certain embodiments includes the identified satellite index, the carrier-to-noise or signal-to-noise ratio of the signal received from the satellite 10, the Doppler frequency associated with that satellite 10, etc. In addition, the initially available information 52 reported to the other sensors 2 can include the location within the pseudorandom noise sequence where the peak was found at the time of packet transmission, thereby facilitating fine-time injection for the other sensors 2. In this regard, the Doppler frequency can be used by the other sensors 2 in order to predict where in the pseudorandom number sequence the peak should be found, and the recipient sensors 2 can use this information to perform a search close to the indicated location. In practice, this can advantageously reduce the search by orders of magnitude. In addition, the signal-to-noise ratio can be used by the other sensors to set the sensitivity of their satellite search appropriately.

In certain implementations, the individual sensors 2 receive pseudorange information related to one or more of the satellites 10 from another sensor 2 via the wireless transceivers 6, and store this pseudorange information (information 50 in FIG. 1) in the electronic memory 30. Moreover, the individual sensors 2 in certain embodiments compute a pseudorange related to a given identified (e.g., acquired) satellite 10, and store this in the memory 30, and may further provide the computed pseudorange (and Doppler frequency) related to the given satellite 10 to the other sensors 2 via the wireless transceiver 6. In this manner, the pseudorange and Doppler frequency information is distributed out to the participating sensors 2 of the system 12, thereby facilitating time and position computation within the system 12. Moreover, as discussed above, the sensor apparatus 2 is configured to share soft demodulation information 60 related to one or more of the satellites 10, and to store this information 60 locally in the electronic memory 30.

As previously noted, moreover, a single sensor 2 takes between 12 and 30 seconds to decode a complete ephemeris for a given satellite 10, whereas the illustrated location sensors 2 decode and broadcast the part of the ephemeris that they have decoded, whereby all the sensors 2 in the system 12 obtain the decoded ephemeris portions 54 and store these in their local electronic memories 30 much faster than a single sensor can, thereby significantly reducing the time to first fix for all the sensors 2 in the system 12. Moreover, the almanac decoding tasks and intermediate results are also shared among the sensors 2 of the system 12. In certain embodiments, for example, each sensor 2 can concatenate its measurements to those it receives in the almanac data 56 of the memory 30 so that the sensor 2 does not need to listen for the full 12.5 minutes, instead the sensors can share the burden of demodulating the almanac so that across a 12.5 minute interval there are a minimal number of sensors actively demodulating at once. Moreover, although decoding the almanac information 56 is not strictly required to perform position determination, having the almanac 56 facilitates longer sleep times in the tracking phase for the sensors 2, and thus the distributed sharing of the almanac information decoding functions facilitates reduced power consumption within the system 12 and within the individual sensors 2 thereof.

Moreover, the sensors 2 advantageously share soft demodulation information 60 about the bits being transmitted, thereby effectively improving system sensitivity when soft information 60 from multiple sensors 2 is combined. For example, as seen at 160 and 162 in FIG. 5 above, the selective employment of shared soft information 60 may advantageously allow a sensor 2 to complete an ephemeris decoding operation that would have otherwise failed in a sensor 2 operating alone. In addition, the soft information 60 may be used for data wipe-off in certain embodiments. A single sensor may accumulate enough soft information over time to allow it to decode the ephemeris over time, but with multiple sensors sharing soft information the system need not wait so long to get a valid ephemeris decoded.

In certain embodiments, the sensors 2 receive initial time of day information 62 (coarse time of day) from other location sensors 2 via the wireless transceiver 6, and store these in the electronic memory 30 as shown in FIG. 1. In addition, the exemplary sensors 2 are operative to determine time of day information based at least partially on the communications signaling received by the wireless receiver 4 from the given identified satellite 10, and provide this (fine) time of day information 62 to the other location sensors 2 via the wireless transceiver 6. In various implementations, moreover, at least one of the sensors 2 in the system 12 is configured to periodically provide the time of day information 62 to the other location sensors 2 via the wireless transceiver 6. In a cold start situation where none of the sensors 2 begins with time of day knowledge, the search space for searching satellites 10 over time and frequency ranges is initially quite large. However, once a sensor 2 decodes the time of day information 60, 62, that sensor 2 advantageously shares the time and day information with the other sensors 2, thereby reducing the uncertainty and thus the search space over which the other sensors 2 will search for satellites 10.

In addition, once a particular sensor 2 gets a time fix and knows the GPS time with accuracy (e.g., less than 1 ms), that sensor 2 can send a message via the wireless transceiver 6 that includes a timestamp of the time of transmission for that packet according to GPS. Consequently, any receiver 2 within range will then know the time of day very accurately by decoding the packet and noting it's time of arrival, thereby greatly reducing its search space. Moreover, sensors 2 can re-broadcast the fine time of day information 64 after adding a delay associated with re-transmission, thereby ensuring that the entire system 12 can benefit as soon as possible after the first sensor 2 gets a time fix. Thus, this time of day sharing aspect of the present disclosure advantageously reduces the amount of processing overhead and consumed power involved in the acquisition and tracking operation of the sensors 2 of the system 12. Also, once a sensor 2 is synchronized to GPS, it can send out messages regularly with timestamps so that other sensors could synchronize their frequencies, and easily resume tracking operation when transitioning from sleep mode, thereby further facilitating energy conservation within the sensors 2 of the system 12.

The system 12 also advantageously shares position and uncertainty information 66, with the individual sensors 2 in certain embodiments receiving position information from one or more other sensors 2 via the wireless transceiver 6, and storing this information in the electronic memory 30, and providing their individual computed sensor position 66 to the other location sensors 2 via the wireless links 8. This position information sharing aspect will further reduce the search space for the other sensors 2 that have not yet computed their own position 66. In certain embodiments, moreover, the location sensors 2 cooperatively compute distances between individual sensor pairs, thereby facilitating estimation by a given sensor 2 of its position prior to the more accurate position determination possible in tracking mode.

In certain embodiments, the messaging between sensors 2 may have different priorities. For example, messaging relaying the time of day and the announcement of the acquisition or identification of a new satellite 10 may have high priority, as these are particularly helpful to the other sensors 2.

In operation of the system 12, moreover, once all the sensors 2 are tracking the satellites 10 on their own, one, some or all of the sensors 2 may go into a low-power mode in which the GPS receiver 4 is put into a sleep mode. In one possible implementation, a single sensor 2 may remain active and track the satellite broadcasts, and periodically transmit the time of day to the other sensors 2, such that sensors 2 waking up from the low-power mode can quickly lock onto the satellite signals, thereby conserving the overall power consumption within the system 12. In this regard, once at least four satellites have been acquired, and the corresponding ephemeris 54 and almanac 56 have been decoded, the system 12 can conserve power while merely searching for and decoding ephemeris for new satellites 10 that become visible as time passes. One possible implementation conserves system resources by ensuring that at least one sensor 2 always remains awake, thereby ensuring that multiple sensors 2 do not decode an ephemeris associated with a newly visible satellite 10. One possible implementation would be for each sensor 2 to be configured to refrain from going into a sleep or low-power mode until receiving an acknowledgment from another sensor 2 that the other sensor will remain awake.

In other embodiments, the GPS receiver 4 in the individual sensors 2 may implement power saving strategies, including without limitation signal blanking. For example, if the signal blanking intervals are less than 20 ms, data demodulation can still be performed although with degraded sensitivity. Having multiple sensors 2 to cooperate facilitates recovery of the loss and sensitivity due to blanking. Moreover, for longer blanking intervals (e.g., more than 20 ms), multiple sensors 2 can cooperate to successfully complete the data demodulation with their signal blanking intervals being interleaved.

In certain embodiments, the sensors 2 may track the carrier-phase of the satellite signals, to facilitate precise measurements.

In certain embodiments, moreover, the sensors 2 may also share other information. For example, sensors 2 equipped with pressure sensing components may share pressure readings to facilitate estimation of elevation or altitude more accurately.

In certain embodiments, the individual sensors 2 can acquire a limited number of satellites 10 in parallel in order to minimize complexity. In such implementations, the sensors 2 may include dedicated hardware for acquisition, as well as separate hardware for tracking, thereby limiting power consumption during tracking mode operation. In other possible implementations, the same hardware may implement both acquisition and tracking mode operation, but with reduced power consumption during tracking operation. These techniques, moreover, are applicable to any GPS or other satellite-based navigation system receiver architectures, including without limitation delay locked loop (DLL) and frequency locked loop (FLL) approaches.

As discussed above, moreover, the sharing of soft demodulation information can facilitate expeditious decoding of orbital information, including ephemeris information 54. For example, once one sensor 2 has acquired a satellite 10 depending on the signal-to-noise or carrier-to-noise ratio of the acquired signal, most or all of the other sensors 2 can stop looking for that satellite 10 and proceed to search for a different satellite 10. Two or more remaining sensors can cooperate to decode the ephemeris of the acquired satellite 10. In the above described implementations, if the signal has a low signal-to-noise ratio, then more sensors 2 may remain to decode the ephemeris cooperatively, and combining soft information from multiple sensors 2 for the ephemeris will facilitate decoding at a lower signal-to-noise ratio. In certain implementations, moreover, a given sensor 2 may listen to the ephemeris multiple times to further improve sensitivity, and the sensors 10 can optionally enter a sleep mode to conserve power or search for other satellites 10 while the ephemeris is not being broadcast, since only two of the five subframes (subframes 202 and 203 in FIG. 6 above) include ephemeris information. In certain implementations, if the signal-to-noise ratio is very low, the satellite 10 may not be identified as being acquired unless multiple sensors 2 acquire the corresponding signal and validate each other by finding the same pseudorandom noise code being transmitted at the same time.

The inventors have appreciated that two sensors 2 may not be able to accurately demodulate any of the words in the frame 200 (FIG. 6), and may thus synchronize with one another to cooperate and share soft demodulation information 60 (FIG. 1). In one possible example, the sensors 2 are assumed to be able to detect a transition of a data bit from a 0 to a 1 or 1 to 0. In one possible embodiment, the sensors 2 initially send their soft information 6 for each data bit (e.g., every 20 ms in a GPS example), beginning after the data-bit boundaries are detected by the wireless receiver 4. If at least one 30-bit word is decoded correctly (e.g., parity check passes), then the sensors 2 aggregate and exchange soft information 60 in larger pieces via the wireless transceiver 6 in order to reduce overhead in transmission of the data. In one possible example, the messaging packet includes a satellite index to ensure that the sensors 2 apply the soft information 60 to the right demodulation signal. The receiving sensors 2 will associate soft information 60 from another sensor 2 with the most recent data bit detected. The soft information may be weighted and combined with the sensor's own demodulation in certain implementation. In this example, a bit decision would be resolved as sign (weighted sum of soft information for this bit from all nodes), and the weights could be derived from the signal-to-noise ratio seen at each sensor 2, or for simplicity equal weights may also be used.

The following numerical example illustrates certain advantages of the disclosed sensor apparatus 2 and multi-sensor systems 12, assuming a Doppler uncertainty range of +/−15 kHz due to a low quality receiver clock, where the number of Doppler bins is M=30000*T_{coh}/k. The parameters T_{coh} and k can be tuned for maximized sensitivity with T_{coh}=0.02 and k=0.5, with M=1200 and for minimized sensitivity with T_{coh}=0.001 and k=1, with M=30. Assuming that N_{non-coh} coherent intervals are combined non-coherently so that the total integration time is T=N_{non- coh}T_{coh}, there are M*N different correlations to be done for each satellite 10 every 1 ms (in GPS), and also assuming that it is equally likely that the satellite 10 could be found in any of the M*N correlation bins. If there are S sensor nodes 2 and each node 2 randomly chooses the time and frequency with which it begins to search, the system 12 can cover S/F correlation bins in T seconds, where F is the overlap in the searches due to non-optimal coverage of the sensor searches. In the GPS example, moreover, there are 32 possible satellites 10 to search. Assuming a time to first fix requirement of 12 hours, there are S sensors 2 cooperating that can each compute C correlations in T seconds, F=0.25, there are Nsv=32 SVs to search, and maximal sensitivity is used with T=1 sec by all sensors 2. Also assuming that once one sensor 2 acquires a satellite 10, the information is propagated quickly through the system 12 so that the time to first fix is dominated by the time to acquire the first satellite 10. Additionally assuming that there are always at least Nmin=4 satellites 10 visible at a given time, the number of sensors 2 required to meet the specification is:

S>T·Nsv·M·N·k/(F·C·TTFF·Nmin)

For C=1 (the simplest possible receiver), then S>909. If fewer sensors 10 or a faster time to first fix is desired, then the individual sensors 2 may be more complex. For example, if a given sensor 2 is capable of searching 1023 correlation bins at a time and the time to first fix requirement is 5 min, then S>128 sensors 2 should be used. Techniques to take advantage of the circular nature of the PRN sequence make this option of C=1023 feasible. Other techniques are available to search multiple Doppler bins with a small degradation in sensitivity due to sinc roll off, so that C=3*1023 is not unreasonable, and this would give S>42.7. If the minimal sensitivity settings are used, then the number of sensors 2 to meet the TTFF requirement reduces by a factor of 40.

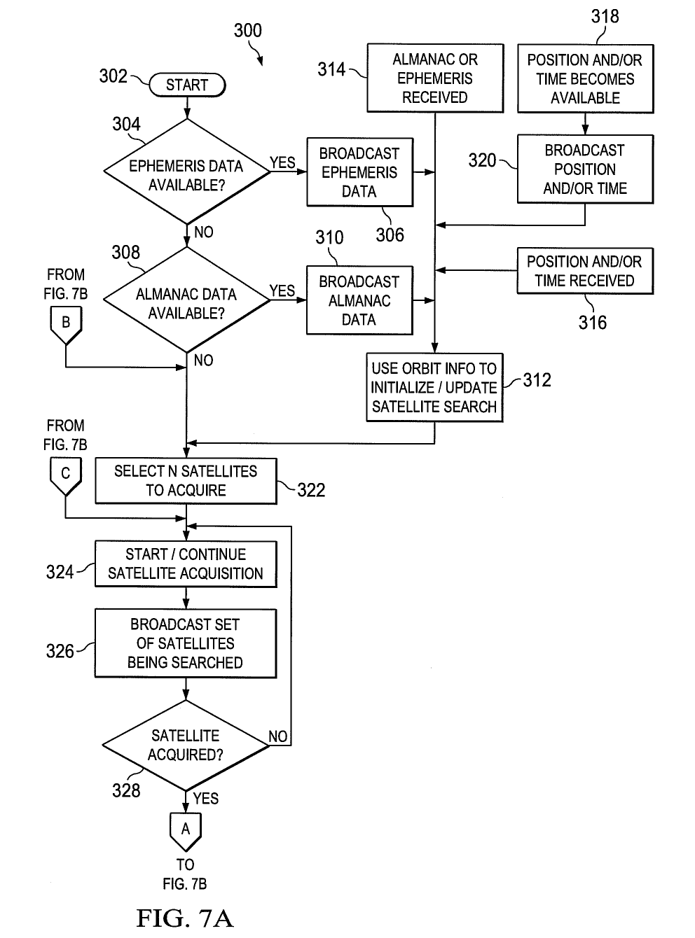

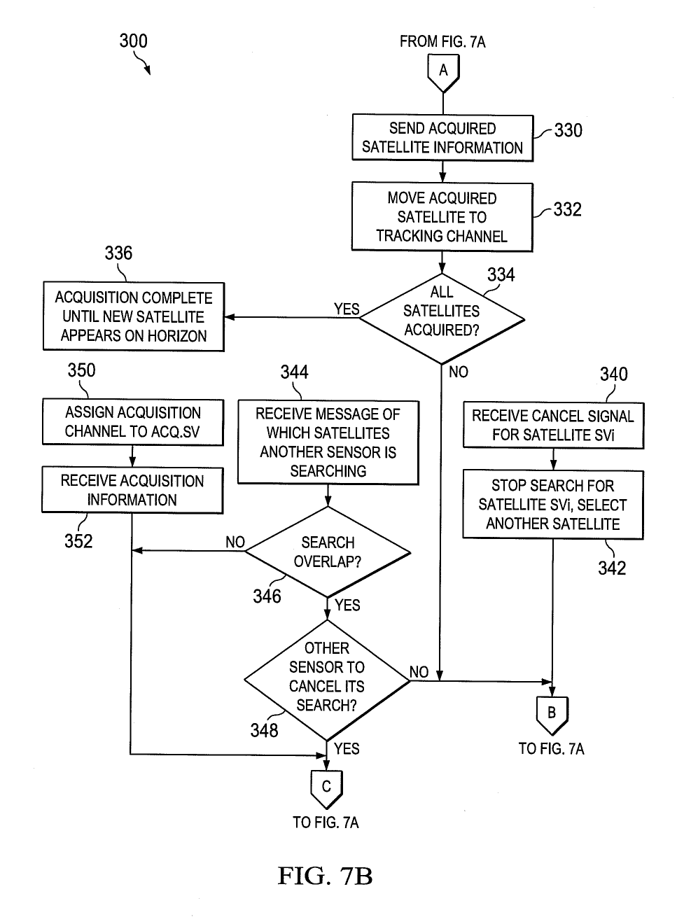

FIGS. 7A and 7B illustrate another example of processing operation 300 in the sensor apparatus 2. In certain embodiments, the sensor 2 is configured to use any available orbital information in the electronic memory 30 to initialize or update the satellite search when the sensor position 66 or the time of day 62, 64 become available. The process 300 in FIGS. 7A and 7B is particularly advantageous where low power consumption is desired, and assumes that each sensor 2 is configured to acquire an integer number N satellites 10 in parallel and to track an integer number M satellites 10 in parallel. Beginning at 302 in FIG. 7A, a determination is made by the sensor 2 at 304 as to whether the ephemeris data is available (e.g., ephemeris 54 in the memory 30 in FIG. 1 above). If so (YES at 304) the ephemeris data is broadcast at 306. Otherwise (NO at 304) the sensor 2 determines whether the almanac data 56 is available in the memory 30, and if so this is broadcast at 310 via the wireless transceiver 6. If no ephemeris data or almanac data are available (NO at 304 and 308), the normal satellite searching process is begun or resumed at 322. If either the ephemeris or the almanac are broadcast and available and at 306 or 310, the process 300 continues at 312 with the sensor 2 using the available orbital information to initialize or update the satellite search. In another possible situation, an almanac or ephemeris is received at 314 from another sensor 2 via the wireless transceiver 6, and this is used at 312 to initialize or update the satellite search. Alternatively or in combination, position and/or time information may be received at 316, or computed position and/or fine time information becomes available at 318, which is broadcast at 320, after which the satellite search is initialized or updated at 312 using the orbital information.

At 322 in FIG. 7A, an integer number N satellites 10 are selected for acquisition, and the sensor 2 begins or continues acquisition at 324 and broadcasts a set of satellites 10 (e.g., satellite indexes) being searched at 326. A determination is made at 328 as to whether a searched satellite has been identified or acquired, and if not (NO at 328), the searching continues at 324 and 326.

Once one of the parallel-searched satellite indexes has been identified (YES at 328 in FIG. 7A), the process 300 continues at 330 in FIG. 7B, with the acquiring sensor 2 sending the acquired satellite information to the other sensors 2, and the acquired satellite 10 is moved to the tracking channel at 332. The tracking channel in one embodiment will handle data demodulation, and soft demodulation combining. A determination is made at 334 as to whether all satellites 10 have been acquired, and if so (YES at 334), the acquisition is deemed complete at 336 until a new satellite 10 appears on the horizon. Otherwise (NO at 334), the sensor 2 processes another integer number N satellites 10 for acquisition at 322 in FIG. 7A as described above.

If a cancel signal is received at 340 in FIG. 7B for a particular satellite 10 (SVi in the figure), the sensor 2 stops searching for that satellite 10 at 342, and selects another satellite index from the list in the memory 30, and the process returns to 322 in FIG. 7A as described above.

If a message is received at 344 in FIG. 7B indicating the satellite 10 is being searched by another sensor 2, a determination is made at 346 as to whether a search overlap exists. If not (NO at 346) the sensor 2 returns to begin or continue satellite acquisition at 324 in FIG. 7A as described above. Otherwise (YES at 346 in FIG. 7B), the sensor 2 may request (via messaging using the wireless transceiver 6) that the other sensor 2 cancel its search. If the other sensor 2 declines (NO at 348), the process returns to 322 in FIG. 7A with the sensor 2 selecting another integer number N satellites 10 to acquire as described above. Otherwise, if the other sensor 2 cancels its search (YES at 348 in FIG. 7B), the sensor 2 begins or continues satellite acquisition at 324 in FIG. 7A as described above. Also, if an acquisition channel has been assigned to the acquired satellite 10 at 350 in FIG. 7B (ACQ.SV=index of the satellite 10 that was acquired), the sensor 2 receives acquisition information at 352 from another sensor 2 (e.g., via the wireless transceiver 6), and returns to 324 in FIG. 7A to start or continue satellite acquisition as described above.

In this process 300, the use of the orbital information at 312 in FIG. 7A to initialize or update the satellite search advantageously expedites processing, thereby minimizing power consumption in the system 12. In one possible implementation, when a satellite signal is being demodulated, that particular satellite 10 is being tracked using one of the tracking channels instead of one of the acquisition channels. One possible application would be GPS enabled watches that are not connected to a cellular network (or other network) to implement assisted GPS. At least one sensor 2 in the system 12 performs a cold start, and the system 12 utilizes the sensors 2 to cooperatively acquire satellites 10 to identify the following acquisition information: ACQ.SV=index of the satellite 10 that was acquired, ACQ.SNR=signal-to-noise ratio of signal that was acquired, and ACQ.Doppler=Doppler frequency used to acquire the satellite 10.

Satellite searches may thus be advantageously updated or started using any available orbital information at 312. For example, available almanac information 56 in the memory 30 may be used to determine whether two particular satellites 2 can be visible at the same time. If the satellite 10 being searched (and not yet acquired) is thus determined to be not visible at the same time as a satellite 10 that has been acquired, then the sensors 2 in the system 12 can stop searching for that satellite 10. In addition, if ephemeris information 54 is available for a given satellite 10, that satellite 10 may be assigned to one of the acquisition channels, and the search can be centered on the Doppler frequency found by another sensor 2 using the code-phase used by the other sensor 2 and the acquisition parameters appropriate for the SNR found by the other sensor 2. This will allow the sensor 2 to acquire the satellite 10 quickly, and move it into its set of satellites 10 being tracked. This example is the same as assigning the index to an acquisition channel at 350 in FIG. 7B. If position or time becomes available at 318 in FIG. 7A and almanac information 56 is available, then the sensor 2 can know which satellites 10 should be available for acquisition, and can therefore conserve resources and power by refraining from searching for any other satellites 10. Also, if the position or time becomes available at 318 and an ephemeris is available (YES at 304), then the search can be narrowed around the expected Doppler frequency. In certain embodiments, moreover, the determination at 348 in FIG. 7B as to whether another sensor 2 will cancel its search for search overlap situations can involve the above-described technique for allowing the sensor 2 that has been searching the longest to continue searching, with the other sensor 2 refraining from searching for that satellite 10. In one possible implementation, a sensor 2 receiving an announcement, and which has been searching for the same satellite 10 the longest, sends a cancellation notice to the announcing sensor 2.

In certain situations, once position and time are known, it is possible that a satellite 10 that should be visible cannot be acquired. This may happen, for example, if there are objects in the vicinity of the sensor 2 that block the signal from the satellite 10. In this case, the sensor 2 may stop searching that satellite 10 for a period of time and try again later after the satellite 10 has had sufficient time to move (the obstruction or sensor may also move). In addition, if the sensor 2 has the capability to detect when it moves, it can try again after a certain amount of movement.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of multiple implementations, such feature may be combined with one or more other features of other embodiments as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What is claimed is:

1. A location sensor apparatus, comprising:
a wireless receiver operative to receive communications signaling from a plurality of satellites;
a wireless transceiver operative to communicate with at least one other location sensor;
an electronic memory; and
at least one processor operatively coupled with the wireless receiver and the wireless transceiver, and configured to:
identify a given satellite based at least partially on the communications signaling received by the wireless receiver,
provide initial information received from the given satellite to the at least one other location sensor via the wireless transceiver;
selectively decode orbital information related to the given satellite based at least partially on the communications signaling received from the given satellite,
provide decoded orbital information related to the given satellite to the at least one other location sensor via the wireless transceiver,
store the decoded orbital information related to the given satellite in the electronic memory, and
selectively compute a sensor position based at least partially on the decoded orbital information in the electronic memory.

2. The apparatus of claim 1, wherein the at least one processor is configured to:
receive decoded orbital information related to one or more of the plurality of satellites from the at least one other location sensor via the wireless transceiver; and
store the decoded orbital information received from the at least one other location sensor in the electronic memory.

3. The apparatus of claim 2, wherein the at least one processor is configured to:
provide an identity of the given satellite and a carrier-to-noise ratio or signal-to-noise ratio of the communications signaling received by the wireless receiver from the given satellite to the at least one other location sensor via the wireless transceiver;
selectively decode the orbital information related to the given satellite based at least partially on the communications signaling received from the given satellite if the decoded orbital information related to the given satellite is not already in the electronic memory and if the at least one other location sensor is not decoding the orbital information related to the given satellite with a sufficiently high carrier-to-noise ratio or signal-to-noise ratio; and
selectively refrain from decoding the orbital information related to the given satellite if the decoded orbital information related to the given satellite is already in the electronic memory or if the at least one other location sensor is decoding the orbital information related to the given satellite with a sufficiently high carrier-to-noise ratio or signal-to-noise ratio.

4. The apparatus of claim 3, wherein the orbital information related to the given satellite includes at least one of ephemeris information related to an orbit of the given satellite and almanac information related to orbits of at least two of the plurality of satellites.

5. The apparatus of claim 1, wherein the at least one processor is configured to:
receive pseudorange information related to one or more of the plurality of satellites from the at least one other location sensor via the wireless transceiver;
store the pseudorange information received from the at least one other location sensor in the electronic memory;
compute a pseudorange related to the given satellite;
store the pseudorange related to the given satellite in the electronic memory;
provide the pseudorange related to the given satellite to the at least one other location sensor via the wireless transceiver;

6. The apparatus of claim 1, wherein the at least one processor is configured to:
receive soft demodulation information related to one or more of the plurality of satellites from the at least one other location sensor via the wireless transceiver;
store the soft demodulation information received from the at least one other location sensor in the electronic memory;
provide soft demodulation information related to the given satellite to the at least one other location sensor via the wireless transceiver; and
selectively use the soft demodulation information in decoding the orbital information related to the given satellite.

7. The apparatus of claim 1, wherein the at least one processor is configured to:
receive first time of day information from the at least one other location sensor via the wireless transceiver;
store the first time of day information received from the at least one other location sensor in the electronic memory;
determine second time of day information based at least partially on the communications signaling received by the wireless receiver from the given satellite; and
provide the second time of day information to the at least one other location sensor via the wireless transceiver.

8. The apparatus of claim 7, wherein the at least one processor is configured to periodically provide the second time of day information to the at least one other location sensor via the wireless transceiver.

9. The apparatus of claim 1, wherein the at least one processor is configured to:
receive position information from the at least one other location sensor via the wireless transceiver;
store the position information received from the at least one other location sensor in the electronic memory; and
provide the computed sensor position to the at least one other location sensor via the wireless transceiver.

10. The apparatus of claim 1, wherein the at least one processor is configured to send a help request message to the at least one other location sensor via the wireless transceiver if no satellites are identified after a predetermined time period.

11. The apparatus of claim 1, wherein the at least one processor is configured when the sensor position or time of day become available, to use available orbital information in the electronic memory to initialize or update a satellite search.

12. The apparatus of claim 11, wherein the at least one processor is configured when the sensor position or time of day become available to use available almanac information related to orbits of at least two of the plurality of satellites to selectively stop searching for at least one of the plurality of satellites which cannot be currently visible.

13. The apparatus of claim 11, wherein the at least one processor is configured when the sensor position or time of day become available to use available ephemeris information related to an orbit of the given satellite to narrow a search for the given satellite around an expected Doppler frequency included in the available ephemeris information.

14. The apparatus of claim 11, wherein the at least one processor is configured to:
receive information from the at least one other location sensor via the wireless transceiver, the received information indicating that the at least one other location sensor is searching for a particular satellite; and
selectively refrain from searching for the particular satellite if the at least one other location sensor has been searching longest for the particular satellite.

15. A location sensor apparatus, comprising:
a wireless receiver operative to receive communications signaling from a plurality of satellites;
a wireless transceiver operative to communicate with at least one other location sensor;
an electronic memory; and
at least one processor operatively coupled with the wireless receiver and the wireless transceiver, and configured to:
identify a given satellite based at least partially on the communications signaling received by the wireless receiver, and
provide initial information received from the given satellite to the at least one other location sensor via the wireless transceiver.

16. A system, comprising:
a plurality of location sensors individually including a programmed processor, an electronic memory, a wireless receiver operated by the processor to receive communications signaling from a plurality of satellites, and a wireless transceiver operated by the processor to communicate with at least one other location sensor;
the individual location sensors storing and cooperatively exchanging information related to acquiring at least four of the plurality of satellites to facilitate determination of their positions;
the individual location sensors searching for satellites by:
selecting a satellite index corresponding to an unlocated one of the plurality of satellites from the corresponding electronic memory,
wirelessly broadcasting the selected unlocated satellite index to at least some of the other individual location sensors via the corresponding wireless transceiver, and
beginning a search for the unlocated one of the plurality of satellites at a random circular rotation of a pseudorandom noise sequence of the location sensor to facilitate sharing of satellite searching resources among at least some of the plurality of location sensors.

17. The system of claim 16, wherein the individual location sensors are configured to:
receive decoded orbital information related to one or more of the plurality of satellites from at least one other location sensor via the wireless transceiver;
store the decoded orbital information received from the at least one other location sensor in the electronic memory;
provide an identity of the given satellite and a carrier-to-noise ratio or signal-to-noise ratio of the communications signaling received by the wireless receiver from the given satellite to the at least one other location sensor via the wireless transceiver;
selectively decode the orbital information related to the given satellite based at least partially on the communications signaling received from the given satellite if the decoded orbital information related to the given satellite is not already in the electronic memory and if the at least one other location sensor is not decoding the orbital information related to the given satellite with a sufficiently high carrier-to-noise ratio or signal-to-noise ratio; and
selectively refrain from decoding the orbital information related to the given satellite if the decoded orbital information related to the given satellite is already in the electronic memory or if the at least one other location sensor is decoding the orbital information related to the given satellite with a sufficiently high carrier-to-noise ratio or signal-to-noise ratio.

18. The system of claim 16, wherein at least two of the plurality of location sensors use different sensitivity settings to search for satellites.

19. The system of claim 16, wherein the individual location sensors are configured to provide initial information received from a located satellite to at least one other location sensor via the wireless transceiver, the initial information comprising:
an index of the located satellite;
a carrier-to-noise ratio or signal-to-noise ratio of a signal received from the located satellite;
a Doppler frequency associated with the located satellite; and
a location in the pseudorandom noise sequence where the signal was found.

20. The system of claim 16, wherein at least two of the plurality of location sensors cooperate to compute distances between themselves.
